(19) United States
(12) Patent Application Publication
(10) Pub. No.: US 2010/0242901 A1
(43) Pub. Date: Sep. 30, 2010

(54) CONTROL OF INTERNAL COMBUSTION ENGINE

(75) Inventors: Masatoshi Seto, Hatsukaichi-shi (JP); Takeo Yamauchi, Aki-gun (JP); Hidefumi Fujimoto, Hiroshima-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: MAZDA MOTOR CORPORATION, Aki-gun (JP)

(21) Appl. No.: 12/749,430

(22) Filed: Mar. 29, 2010

(30) Foreign Application Priority Data
Mar. 31, 2009 (JP) 2009-087586

(51) Int. Cl. F02B 3/00; F02D 41/00

(52) U.S. Cl. 123/299; 123/435

(57) ABSTRACT

An exemplary method for controlling an internal combustion engine system includes, when a desired torque is equal to or greater than a first torque, opening an exhaust valve and injecting pilot fuel into a combustion chamber at a first pressure before an exhaust top dead center in a cylinder cycle, opening an intake valve in the cylinder cycle after said injecting, and injecting main fuel in the cylinder cycle after said opening of said intake valve. The method further includes, when a desired torque is less than said first torque, opening said exhaust valve and injecting pilot fuel into the combustion chamber at a second pressure that is greater than the first pressure before an exhaust top dead center in the cylinder cycle, opening said intake valve in the cylinder cycle after said injecting, and injecting main fuel in the cylinder cycle after said opening of said intake valve.

### BACKGROUND

The present description relates to control of an internal combustion engine having homogeneous charge compression ignition (HCCI) combustion, and more particularly to control of fuel injection during a negative valve overlap period of intake and exhaust valves of a HCCI engine.

There is known, and for example described in U.S. Pat. No. 6,651,677B2 and U.S. Pat. No. 7,156,070B2, a homogeneous charge compression ignition combustion process, hereinafter referred to as “HCCI combustion process”. The process comprises, under a predetermined operating condition, such as a low load and low speed condition, premixing fuel and air substantially homogeneously in the combustion chamber, and heating this mixture above an ignition temperature of the fuel by compressing the mixture with the piston to cause self ignition. In the HCCI combustion process, air fuel mixture of a leaner air fuel ratio can be ignited, leading to lower heat loss and higher thermal efficiency or fuel economy. Further, almost all of the air fuel mixture in the combustion chamber is ignited almost simultaneously and the combustion completes in a relatively short period of time. Therefore, nitrogen and oxygen in the combustion chamber are exposed to a hotter condition for a shorter time period. This leads to less generation of nitrogen oxide or NOx.

The '070 patent discloses providing a negative valve overlap period around the top dead center between the exhaust and intake strokes in a cylinder cycle. In the negative valve overlap period (hereinafter referred to as “NVO period”), both the intake and exhaust valves are closed, and the high temperature combusted gas is retained in the combustion chamber to further raise the temperature in the combustion chamber at the compression stroke in the cylinder cycle for the compression ignition. Further, the '070 patent discloses injecting fuel into the combustion chamber during the NVO period. It will be referred to as “NVO injection”. The fuel is injected into the high temperature gas, reacts with remaining oxygen in the combusted gas, reforms or combusts itself, and generates heat to further raise the temperature in the combustion chamber. This NVO injection raises the temperature in the combustion chamber during the compression stroke thereafter and makes sure that the air fuel mixture is self ignited around the compression top dead center, even in a condition where a desired torque for the engine is lower, a smaller amount of fuel is combusted to generate less heat and the temperature in the combustion chamber around the compression top dead center may not tend to rise enough.

The prior method can certainly cause self ignition around the compression top dead center. However, it has some disadvantage during the lower desired torque condition. Specifically, the NVO injection needs to be started after the closing of the exhaust valve to prevent the injected fuel from flowing out to the exhaust passage without combusting in the combustion chamber, and finished some time before the opening of the intake valve for the reaction of the injected fuel in the higher temperature to occur. If the NVO injection is not completed that some time before the opening of the intake valve, the temperature in the combustion chamber around the compression dead center may not be high enough for the compression ignition. As a result, when the desired torque is smaller, the HCCI combustion process cannot occur and the higher thermal efficiency derived from the HCCI combustion process cannot be obtained.

Therefore, there is room for improvement of the HCCI combustion process in the lower, desired torque condition.

### SUMMARY

The inventors herein have rigorously studied to improve the HCCI combustion process and unexpectedly found a method to control an internal combustion engine system which solves disadvantages of the prior method and presents further advantages.

Accordingly, there is provided, in one aspect of the present description, a method of controlling an internal combustion engine system having an internal combustion engine, and a fuel injector which directly injects fuel into a combustion chamber of the internal combustion engine. The method comprises opening an exhaust valve of a combustion chamber of the internal combustion engine and injecting pilot fuel into the combustion chamber at a first pressure before an exhaust top dead center in a cylinder cycle, opening an intake valve of the combustion chamber in the cylinder cycle after the injecting of pilot fuel, and injecting main fuel in the cylinder cycle after the opening of the intake valve so that the main fuel is self ignited in the cylinder cycle after the intake valve is closed, when a desired torque for the internal combustion engine system is equal to or greater than a first torque. The method further comprises opening the exhaust valve and injecting pilot fuel into the combustion chamber at a second pressure that is greater than the first pressure before an exhaust top dead center in a cylinder cycle, opening the intake valve in the cylinder cycle after the injecting of pilot fuel, and injecting main fuel in the cylinder cycle after the opening of the intake valve so that the main fuel is self ignited in the cylinder cycle after the intake valve is closed, when a desired torque for the internal combustion engine system is less than the first torque.

According to the first aspect, by injecting the pilot fuel at the higher pressure before the exhaust top dead center in the cylinder cycle when the desired torque is smaller, a greater amount of the pilot fuel can be injected in a short period of time. The greater amount of the pilot fuel can raise the temperature in the combustion chamber and eventually raise the temperature around the compression top dead center for the self ignition of the main fuel. On the other hand, when the desired torque is greater, a smaller amount of the pilot fuel is needed to raise the temperature in the combustion chamber around the compression top dead center. In that occasion, by injecting the pilot fuel at the lower pressure, the smaller amount of pilot fuel can be injected during a minimum open duration of the injector, and an excessive amount of fuel injected can be minimized, leading to a fuel economy benefit. Therefore, the method can cause the HCCI combustion process to occur in the lower desired torque condition without deteriorating the higher fuel economy achieved in the higher desired torque condition. As a result, the method can improve the engine operating condition in a wider operating range.

In some embodiments, an amount of the pilot fuel when the desired torque for the internal combustion engine system may be less than the first torque is greater than an amount of the pilot fuel when the desired torque for the internal combustion engine system is equal to or greater than said first torque. Accordingly, as described above, the smaller amount of fuel can be injected during the minimum open duration of the injector, and an excessive amount of fuel injected can be minimized.

Further, in some embodiments, the pilot fuel and the main fuel may be injected at a substantially same pressure in a cylinder cycle. Accordingly, in the lower desired torque condition, the main fuel pressure may be raised and mixing of air and fuel can be improved. On the other hand, in the higher desired torque condition, the main fuel pressure may be lowered and stick of the main fuel to the cylinder wall, which is more likely in this condition, can be suppressed.

Still further, in some embodiments, the method may further comprise injecting a supply of fuel into the combustion chamber at a third pressure that is greater than the first pressure, and igniting the injected supply of fuel with a spark when a desired torque for the internal combustion engine system is greater than a second torque that is greater than the first torque. The third pressure may be greater than the second pressure. Accordingly, when the desired torque is greater, a sufficient amount of fuel for the greater desired torque, can be injected at a desired timing and ignited at a desired timing.

### BRIEF DESCRIPTION OF THE DRAWINGS

FIG. 1 is a schematic diagram showing the entire configuration of an engine provided with a control device according to an embodiment of the present invention.

FIG. 2 is a graph showing an example of a control map for performing an engine control of this embodiment.

FIG. 3 is a chart showing an example of change characteristics of open and close timings of an intake valve and an exhaust valve with respect to an engine load in the case of performing the engine control of this embodiment.

FIG. 4 is a chart showing an example of change characteristics of a supercharge pressure, an intake air amount, an exhaust gas recirculation (EGR) amount, and an air fuel ratio with respect to the engine load in the case of performing the engine control of this embodiment.

FIG. 5A is a diagram showing change characteristics of valve lifts of the intake valve and the exhaust valve with respect to a crank angle in the case of operating the engine in a Spark Ignition mode (SI mode), and FIG. 5B is a diagram showing change characteristics of the valve lifts of the intake valve and the exhaust valve with respect to the crank angle in the case of operating the engine in a Homogeneous Charge Compression Ignition mode (HCCI mode).

FIG. 6 is a flowchart showing a control technique of the engine control (fuel injection control) of this embodiment performed by a PCM.

FIG. 7A is a graph showing a Homogeneous Charge Compression Ignition range (HCCI range) range and a Spark Ignition range (SI range) with an engine load, engine speed, and a required NVO injection amount as parameters, and FIG. 7B is a graph showing the Homogeneous Charge Compression Ignition range (HCCI range) and the Spark Ignition range (SI range) with the engine load, engine speed, and a required fuel pressure as parameters, and FIG. 7C is a graph showing a change characteristic of the fuel pressure with respect to the load.

### DESCRIPTION OF EMBODIMENT

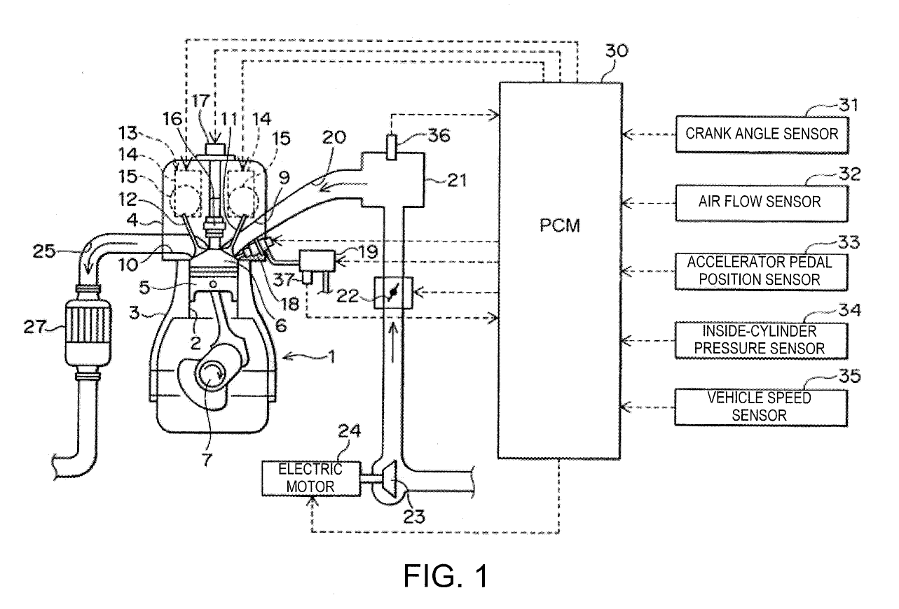

Hereinafter, an embodiment of the present invention is described specifically referring to the appended drawings. As shown in FIG. 1, a multi-cylinder engine (internal combustion engine) using gasoline or the like as fuel is provided with an engine body part 1, which includes a cylinder block 3 having two or more cylinders 2 (for example, four cylinders, six cylinders, etc.) in which the cylinders are arranged in series in a direction which intersects perpendicularly with the drawing sheet, and a cylinder head 4 arranged above the cylinder block 3. A piston 5 is fitted into each cylinder 2 of the engine body part 1, and a combustion chamber 6 with a predetermined capacity is formed between an upper surface of the piston 5 and a lower surface of the cylinder head 4. The pistons 5 are connected with a crankshaft 7 via the respective connecting rods. The crankshaft 7 rotates about its center axis with reciprocating movement of the pistons 5.

Inside the cylinder head 4, two intake ports 9 and two exhaust ports 10 which open in a ceiling part of each combustion chamber 6 are formed in the corresponding cylinder 2. The intake ports 9 extend obliquely upward from the ceiling part of the combustion chamber 6 and open in a side wall on the intake side of the cylinder head 4 (right-hand side in FIG. 1), and the exhaust ports 10 open in a side wall on the exhaust side (left-hand side in FIG. 1). An intake passage 20 and an exhaust passage 25 are connected to each opening part of the intake port 9 and the exhaust port 10 in the side walls, respectively.

Intake valves 11 and exhaust valves 12, a number of which corresponds to a number of the intake ports 9 and the exhaust ports 10, respectively, are provided in a cylinder head 4 for each cylinder 2. The intake port 9 and the exhaust port 10 are opened and closed by the intake valve 11 and the exhaust valve 12, respectively. The intake valve 11 and the exhaust valve 12 are driven so as to be opened and closed by a valve operating mechanism 13 including a pair of camshafts (not illustrated) arranged in the cylinder head 4 so that the open-and-close operation is synchronized with rotation of the crankshaft 7.

Each valve operating mechanism 13 of the intake valve 11 and the exhaust valve 12 is incorporated with a Variable Valve Lift mechanism (hereinafter, referred to as a “VVL”) 14 and a Variable Valve Timing mechanism (hereinafter, referred to as “VVT”) 15, respectively. The VVL 14 changes a pivoting locus of cams attached to the camshaft (not illustrated) based on an instruction from a PCM 30 to change the lifts of the intake valve 11 and the exhaust valve 12 (valve openings) according to an operating state of the engine.

The VVT 15 changes a rotation phase of the camshaft (not illustrated) with respect to the crankshaft 7 based on an instruction from the PCM 30 to change opening and closing timings of the intake valve 11 and the exhaust valve 12 (phase angles) according to the engine operating state. Then, according to the operation of the VVL 14 and the VVT 15, lift characteristics of the intake valve 11 and the exhaust valve 12 are changed, and as a result, an amount of intake air into each cylinder 2 and an amount of residual combusted gas (internal EGR) are adjusted. Note that, because the VVL 14 and the VVT 15 are generally used and are known to a person skilled in the art, the detailed description thereof is omitted herein.

A spark plug 16 is provided to the cylinder head 4 so as to face to the combustion chamber 6 of each cylinder 2. The spark plug 16 discharges a spark (jump spark ignition) at a predetermined timing according to supply of electric current from an ignition circuit 17 provided above the spark plug 16. A fuel injection valve 18 is provided to the cylinder head 4 so as to face to the combustion chamber 6 from the side of the intake side (right-hand side in FIG. 1). Fuel is supplied from a high-pressure fuel pump 19 to the fuel injection valve 18 via a fuel passage. Note that the high-pressure fuel pump 19 may be driven by a spool valve, and can freely change a supply pressure of the fuel to the fuel injection valve 18 (i.e., a fuel pressure) within a wide range from a low pressure to a high pressure, for example by using a spill valve. The fuel injection valve 18 directly injects the fuel into the combustion chamber 6 at a predetermined injection timing (in an intake stroke, for example) to generate air fuel mixture of a predetermined air fuel ratio in the combustion chamber 6.

An intake passage 20 is arranged on the intake side of the engine (FIG. 1). Seeing in an air flow direction (an arrow direction in the figure), a downstream end of the intake passage 20 is connected with the side wall on the intake side of the cylinder head 4, and communicates with the intake port 9. Air, from which foreign substances such as dusts are removed by an air cleaner (not illustrated), passes through the intake passage 20 and the intake port 9 in this order, and is then supplied to the combustion chamber 6 of each cylinder 2.

A surge tank 21 is interposed in an intermediate part of the intake passage 20. The intake passage 20 has a single passage common to all the cylinders (hereinafter, referred to as a “common intake passage part”) upstream of the surge tank 21 when seen in the air flow direction. An electronic control throttle valve 22, which has a “by-wire” connection, is arranged in the common intake passage part, for example. On the other hand, downstream of the surge tank 21, the intake passage 20 has a passage branched for each cylinder 2 (hereinafter, referred to as a “branched intake passage part”). Here, air of which a flow rate is adjusted by the throttle valve 22 passes through the branched intake passage part, and is then introduced into the combustion chamber 6 of each cylinder 2.

With respect to the air flow direction, a supercharger 23 for pressurizing intake air is provided to the intake passage 20 upstream of the throttle valve 22 (i.e., in the common intake passage part). The supercharger 23 is rotated by an electric motor 24 which operates with electric power supplied from a battery (not illustrated), and by controlling a rotation speed of the motor, a supercharge pressure is changed.

The exhaust passage 25 is arranged on the exhaust side of the engine (left-hand side in FIG. 1). With respect to an exhaust gas flow direction (an arrow direction in this figure), an upstream end of the exhaust passage 25 is connected with the side wall on the exhaust side of the cylinder head 4 and communicates with the exhaust port 10. When air fuel mixture combusts in the combustion chamber 6 of each cylinder 2, the combusted gas (exhaust gas) generated by the combustion is discharged to the outside through the exhaust passage 25. A catalytic converter 27 using a three-way catalyst for purifying hazardous components in the exhaust gas is provided in an intermediate part of the exhaust passage 25. In this engine, because there are few amounts of NOx generation, it is not provided with a special device, such as a NOx trap catalyst, for enhancing a processing efficiency of NOx.

The engine is provided with the PCM (Power Train Control Module) 30, as a control device (e.g., controller), with a computer including a CPU and various memories, for comprehensively controlling the engine operation. The PCM 30 is an integrated control device of the engine including a “high load self-ignition control means” and a “low load self-ignition control means”, and is electrically connected with sensors provided in each part of the engine. Specifically, the PCM 30 is electrically connected with a crank angle sensor 31 for detecting a rotation angle (crank angle) of the crankshaft 7, an airflow sensor 32 for detecting an amount of air which flows in the intake passage 20, and an accelerator pedal position sensor 33 for detecting a depressing amount of a non-illustrated accelerator pedal (i.e., an accelerator opening) for operating opening and closing of the throttle valve 22, and an inside-cylinder pressure sensor 34 for detecting a pressure inside the combustion chamber 6 of each cylinder 2, and a vehicle speed sensor 35 for detecting a traveling speed of a vehicle onto which the engine is mounted.

Further, the PCM 30 is electrically connected with an intake air temperature sensor 36 for detecting a temperature of air inside the surge tank 21 (i.e., a temperature of air supplied to the combustion chamber 6 of each cylinder 2), and a fuel pressure sensor 37 for detecting a pressure of fuel supplied to the fuel injection valve 18 from the high-pressure fuel pump 19 (i.e., a fuel pressure or an injection pressure). That is, control information detected by the various sensors 31-37 described above is inputted into the PCM 30 as electric signals.

Based on the detection values of the various sensors 31-37 described above, the PCM 30 integrally controls operation of each component (the VVL 14, the VVT 15, the ignition circuit 17, the fuel injection valve 18, and the high-pressure fuel pump 19) according to the engine operating state to perform various controls of the engine. Here, because control techniques, such as general engine controls (for example, an air fuel ratio control, an ignition timing control, etc.), are well known by a person skilled in the art and the general engine control is not considered to be the gist of the present invention, a control technique relevant to the compressed self ignition according to the gist of the present invention is mainly described below.

The PCM 30 can selectively switch combustion patterns between a Homogeneous Charge Compression Ignition (hereinafter, referred to as an “HCCI”) mode in which air fuel mixture generated beforehand in an intake stroke (premixed air fuel mixture) is caused to carry out compressed self ignition near the end of a compression stroke, and a Spark Ignition (hereinafter, referred to as an “SI”) mode in which air fuel mixture is forcibly ignited by jump spark ignition by using the spark plug 16.

Hereinafter, the function of the PCM 30 is described in more detail. The PCM 30 is hardware, which may be constituted by a substantially integrated computer. Of course, each part or device which constitutes the PCM 30 can be attached to or removed from the PCM 30, if needed. The PCM 30 can also be classified functionally into an operating state determination module, an intake and exhaust control module, a supercharger control module, a fuel injection control module, a memory module, etc.

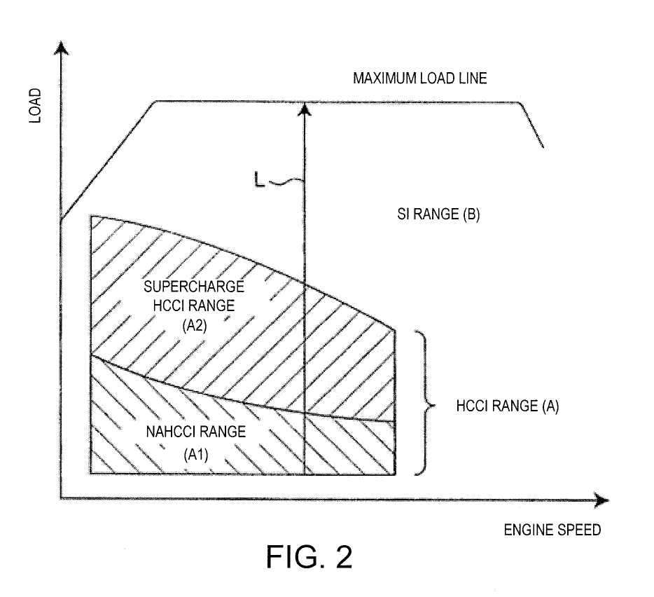

In the PCM 30, the operating state determination module calculates an engine load or a required torque and an engine speed based on the input values from the various sensors 31-37, and then determines which operating range in the control map (refer to FIG. 2) corresponds to an engine operating state, based on the engine load and the engine speed. The intake and exhaust control module changes lift characteristics of the intake valve 11 and the exhaust valve 12 according to the engine operating state by controlling the VVL 14 and the VVT 15; thereby controlling operations of engine intake and exhaust. The supercharger control module controls the drive of the electric motor 24 to control drive/no-drive of the supercharger 23, or the supercharge pressure in the case of driving the supercharger 23 according to the engine operating state.

The fuel injection control module controls a fuel injection amount, a fuel pressure (a fuel injection pressure), an injection pulse width and a fuel injection timing of the fuel injection valve 18, and a driving state and a discharge pressure of the high-pressure fuel pump 19 based on the input values from the various sensors 31-37 according to the engine operating state (hereinafter, this control is referred to as a “fuel injection control”). The memory module stores various data, and programs required for the engine control. Note that the memory module stores a control map for performing various controls according to the engine operating state as shown in FIG. 2, for example.

FIG. 2 shows an example of the control map for performing the engine control. As shown in FIG. 2, two operating ranges of an HCCI range [A] (Homogeneous Charge Compression Ignition range) and an SI range [B] (Spark Ignition range) are set in the control map. An engine combustion pattern is selected according to which range the engine operating state is being operated in (i.e., in the range [A] or the range [B]). Specifically, the SI mode is selected in the SI range [B], which is a high-speed range and/or a high load range, and the HCCI mode is selected in the HCCI range [A], which is a low-speed and low-load range.

The HCCI range [A] is further divided into two ranges [A1] and [A2] according to whether the supercharger 23 is to be operated. That is, in the NAHCCI range [A1] which is at a lower load side among both the ranges [A1] and [A2], driving of the supercharger 23 is stopped and air intake is performed by natural aspiration (NA). On the other hand, in the supercharge HCCI range [A2] which is at a higher load side than the range [A1], the supercharger 23 is driven to pressurize air inside the intake passage 20, thereby supercharging is performed. Then, determination of the engine operating state based on the control map shown in FIG. 2 is performed by the operating state determination module, and based on the determination result, the intake and exhaust control module, the supercharger control module, and the fuel injection control module control the operation of the VVL 14, the VVT 15, the supercharger 23, the fuel injection valve 18, and the high-pressure fuel pump 19.

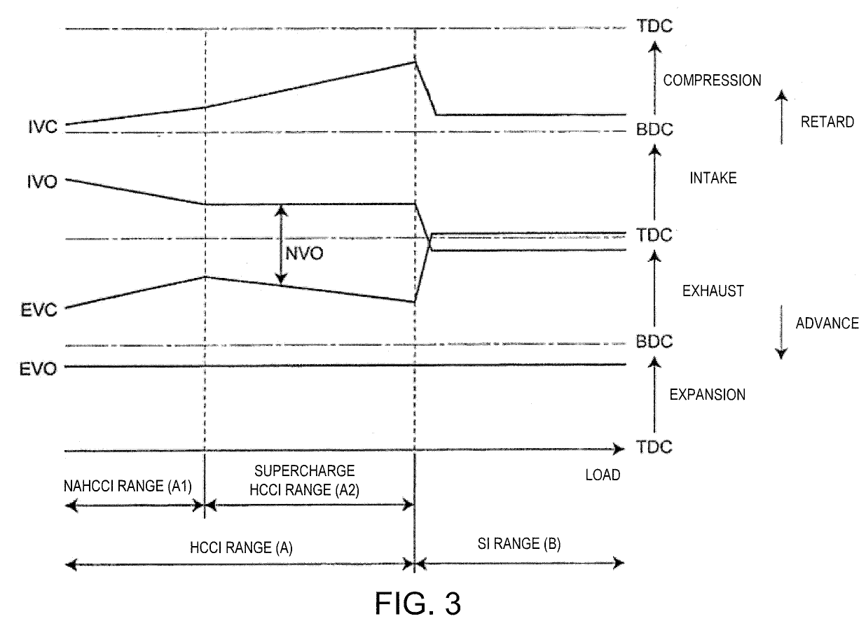

FIG. 3 is a timing chart showing how the opening and closing timings of the intake valve 11 and the exhaust valve 12 are controlled by the intake and exhaust control module. Specifically, FIG. 3 shows how the opening and closing timings of the intake valve 11 and the exhaust valve 12 change according to the engine load when the engine operating state changes as shown by a line L in the control map shown in FIG. 2. In FIG. 3, “IVC” is a valve close time of the intake valve 11, “IVO” is a valve open time of the intake valve 11, “EVC” is a valve close time of the exhaust valve 12, and “EVO” is a valve open time of the exhaust valve 12. In addition, in FIG. 3, an expansion stroke, an exhaust stroke, an intake stroke, and a compression stroke of the engine are indicated in this order upwardly in the vertical direction in this figure. “TDC” and “BDC” represent a “top dead center” and a “bottom dead center,” respectively.

As shown in FIG. 3, when the engine operating state is within the HCCI range [A], the VVL 14 and the VVT 15 are controlled so that the valve close time of the exhaust valve 12 (EVC) is advanced from an exhaust top dead center (a top dead center between an exhaust stroke and an intake stroke) and the valve open time of the intake valve 11 (IVO) retarded from the exhaust top dead center. Thereby, an NVO period where both the intake valve 11 and the exhaust valve 12 are closed is provided from an exhaust stroke to an intake stroke. Further, as described in detail later, an NVO injection is performed during the NVO period by the fuel injection valve 18 to inject a small amount of fuel.

Therefore, also after passing over the exhaust stroke, a predetermined amount of exhaust gas remains in the cylinder 2 as internal EGR gas. Inside the cylinder 2, a main injection is performed by the fuel injection valve 18 mainly in an intake stroke. This fuel is mixed over a sufficient period of time before the second half of a compression stroke, and substantially uniform air fuel mixture (premixed air fuel mixture) is generated. The air fuel mixture generated in this way combusts by self-ignition by increasing its temperature to an ignition temperature or a combustion temperature of the fuel or the air fuel mixture or higher temperature, with heat generated by compression of the piston 5, heat which the internal EGR gas has, and the combustion heat of the fuel injected by the NVO injection.

In the HCCI range [A], the valve close time of the intake valve 11 (IVC) is shifted to the retard side comparatively more greatly than a compression bottom dead center (a bottom dead center between the intake stroke and the compression stroke), and a substantial compression start of the premixed air fuel mixture is set relatively later. For this reason, an effective compression ratio of the cylinder 2 becomes smaller, and a generated amount of heat by the compression is reduced. As a result, an excessive rise in the temperature of premixed air fuel mixture and the resulting abnormal combustion is prevented.

On the other hand, when the engine load becomes larger and the operating state shifts to the SI range [B], the valve open timing of the intake valve 11 (IVO) and the valve close timing of the exhaust valve 12 (EVC) are brought close to an exhaust top dead center, respectively. Thereby, in the SI range [B], the NVO period is not provided and recirculation of the exhaust gas by the internal EGR system is no longer performed. Note that, in the example shown in FIG. 3, a valve open overlap period, where the intake valve 11 and the exhaust valve 12 are both opened around an exhaust top dead center, is provided. In the SI range [B] where the internal EGR is not performed, because the air fuel mixture is not self ignited, combustion of the air fuel mixture is performed by jump spark ignition using the spark plug 16. That is, in the SI range [B], a spark is generated by the spark plug 16 near a compression top dead center (a top dead center between the compression stroke and the expansion stroke). In this way, the air fuel mixture is forcibly combusted by flame propagation from a spark generating module (ignition source).

In the SI range [B], the valve close timing of the intake valve 11 (IVC) is resumed to the timing near a compression bottom dead center, and the effective compression ratio is brought close to the compression ratio according to all the strokes of the piston 5 (geometric compression ratio). For this reason, the air fuel mixture is ignited after being compressed with a sufficient compression ratio and comparatively large combustion energy occurs by this ignition. Note that the valve open timing of the exhaust valve 12 (EVO) is maintained substantially constant over all the operating ranges of the HCCI range [A] and the SI range [B]. Specifically, it is maintained substantially constant at a timing which is slightly advanced from an expansion bottom dead center (a bottom dead center between the expansion stroke and the exhaust stroke).

Thus, the reason why the air fuel mixture is forcibly combusted by jump spark ignition in the SI range [B] set at a high speed side or a high load side is that a sufficiently high output cannot be obtained with the combustion by compressed self ignition performed in the HCCI range [A]. Because a high load side limit of the compressed self ignition range is restrained by an increase in the amount of NOx generation by a rich air fuel ratio, and an increase in the maximum pressure increase rate (resulting in an increase in a combustion noise), combustion by the HCCI mode is not performed, but SI mode where air fuel mixture is forcibly combusted by jump spark ignition is selected. Note that generation of the air fuel mixture in the SI mode is performed by injecting fuel from the fuel injection valve 18 at a proper timing according to the engine load in a period from the intake stroke to the compression stroke, and the fuel injection is performed mainly in the intake stroke in a high load range like the SI range [B].

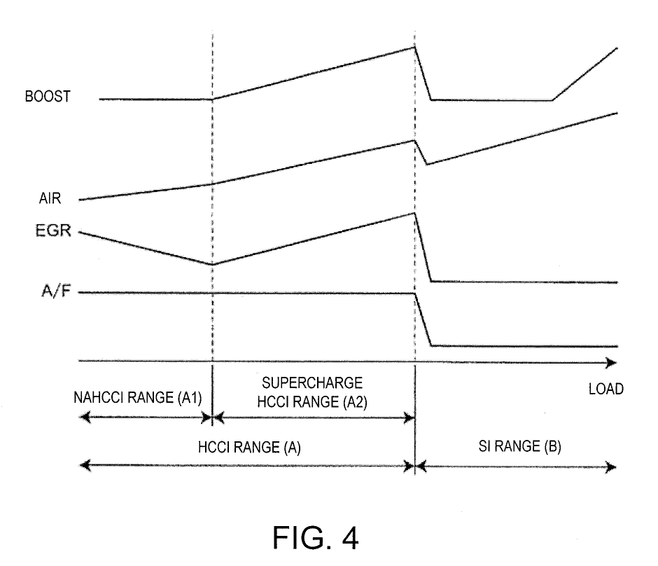

FIG. 4 shows how the supercharge pressure (boost), the intake air amount (air), the EGR amount (EGR), and the air fuel ratio (A/F) change with respect to the engine load. As shown in FIG. 4, because the supercharger 23 does not operate in the NAHCCI range [A1] where the engine load is small, the supercharge pressure (boost) is maintained at zero. Then, when the engine load increases and it shifts to the supercharge HCCI range [A2], the operation of the supercharger 23 is started and the supercharge pressure then increases according to the engine load. By such an operation of the supercharger 23, more air than a quantity according to the opening of the throttle valve 22 is taken into the cylinder 2. For this reason, the intake air amount (air) in the supercharge HCCI range [A2] increases at a higher rate of increase compared with the NAHCCI range [A1]. When the engine load further increases and shifts to the SI range [B] from the supercharge HCCI range [A2], the supercharger 23 is stopped. However, in a range near the entire load, the supercharger 23 is actuated to secure the engine output and, thus, the supercharge pressure is raised.

The amount of internal EGR which remains in the cylinder 2 changes in a substantially V-shape in the HCCI range [A] with the change in the NVO period (refer to FIG. 3). On the other hand, in the SI range [B], because recirculation of the exhaust gas by the internal EGR system is not performed, the quantity becomes zero. Furthermore, the air fuel ratio (A/F) is set to lean in the HCCI range [A] according to the fuel injection amount from the fuel injection valve 18 and the intake air amount, and in the SI range [B], it is set to rich (for example, near a theoretical air fuel ratio).

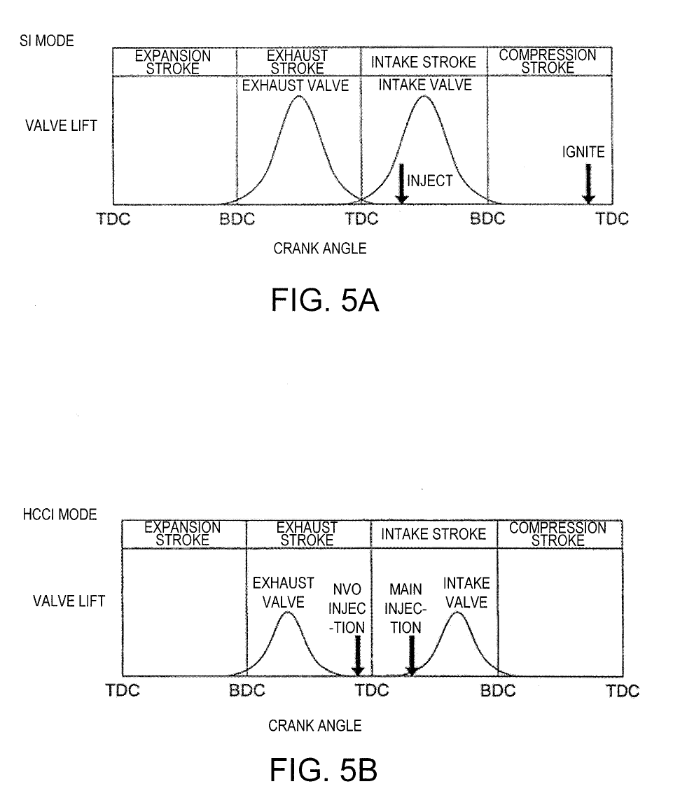

Hereafter, the control technique of the “fuel injection control” according to the gist of the present invention which is performed by the PCM 30 (especially, by the operating state determination module and the fuel injection control module), where the PCM 30 controls the fuel injection amount, the injection pulse width, the fuel injection timing of the fuel injection valve 18, and the discharge pressure of the high-pressure fuel pump 19, is described. First, the outline of the fuel injection control is described referring to FIGS. 5A and 5B.

As shown in FIG. 5B, in this fuel injection control, when the engine operating state is in the HCCI mode, a valve open period of the exhaust valve 12 and a valve open period of the intake valve 11 are set so that the NVO period where both the valves 12 and 11 are closed near an exhaust top dead center exists. Then, the NVO injection (pilot injection) is performed by the fuel injection valve 18 so that the fuel injected during the NVO period before the exhaust top dead center is self ignited. Then, after the NVO period is finished and the intake valve 11 is opened after the exhaust top dead center, the main injection is performed by the fuel injection valve 18. Note that the fuel injected by the NVO injection is a very small amount compared with the fuel injected by the main injection.

In this way, in the second half stage of an intake stroke and the first half stage of a compression stroke, substantially uniform air fuel mixture (premixed air fuel mixture) is formed in the combustion chamber 6. This air fuel mixture is self ignited near a compression top dead center. As a result, the air fuel mixture or fuel combusts quickly without producing flame propagation. In this case, because a combustion temperature is low compared with the case of jump spark ignition, an amount of NOx generation is significantly reduced.

In the HCCI mode, because the NVO period is provided, hot internal EGR remains in the combustion chamber 6 and, thus, the temperature of air fuel mixture can be raised in a compression stroke. Further, in the NVO injection, by injecting fuel into the hot internal EGR inside the combustion chamber 6 and reforming this fuel, and by combusting the fuel to generate combustion heat, the temperature of air fuel mixture can fully be raised in the next compression stroke. As a result, the self-ignition of the air fuel mixture can be certainly secured.

When the required torque (or the engine load) is a first predetermined torque (or a first engine load) or more (hereinafter, referred to as “at the time of high load self-ignition”), the NVO injection is performed at the first fuel pressure. On the other hand, when the required torque (or the engine load) is below the first torque (or the first engine load) (hereinafter referred to as “at the time of low load self-ignition”), the NVO injection is performed at a second fuel pressure higher than the first fuel pressure.

Here, the fuel injection amount of the NVO injection at the time of low load self-ignition is made more than the fuel injection amount of the NVO injection at the time of high load self-ignition. Further, in the same cylinder cycle, a fuel pressure of the NVO injection and a fuel pressure of the main injection are made equal or almost equal. Here, in the HCCI mode, when performing the NVO injection, the fuel injection amount may be increased as the required torque or the engine load becomes smaller. In this case, it is preferred to increase the fuel injection amount by making the fuel pressure (i.e., the fuel injection pressure) higher as the required torque or the engine load becomes smaller.

On the other hand, as shown in FIG. 5A, when the engine operating state is in the SI mode, the valve open period of the exhaust valve 12 and the valve open period of the intake valve 11 are set so that the valve open periods of both the valves 12 and 11 overlap with each other near an exhaust top dead center. Then, after the intake valve 11 is opened after the exhaust top dead center, fuel injection is performed only once. Then, air fuel mixture is ignited by the spark plug 16 before a compression top dead center. As a result, the air fuel mixture or fuel combusts by flame propagation. Note that the fuel pressure in the SI mode is set higher than the first fuel pressure or the second fuel pressure in the HCCI mode.

In this way, in this fuel injection control, because the fuel pressure of the NVO injection is made high at the time of low load self-ignition when the engine operating state is in the HCCI mode, a greater amount of fuel can be injected certainly within the limited NVO period by the NVO injection. Therefore, a greater amount of heat can be generated, the self-ignition temperature near a compression top dead center can be secured, and the HCCI range can be expanded to a lower load side. Further, because the fuel pressure is high, microatomization of the fuel is stimulated, the flammability of the fuel becomes good, and generation of smoke resulting from the increase in the amount of the NVO injection can be prevented or suppressed.

On the other hand, because the fuel pressure of the NVO injection is low at the time of high load self-ignition when the engine operating state is in the HCCI mode, the NVO injection can be performed with a small injection amount as much as possible, while minimizing the valve open period of the fuel injection valve 18. That is, at the time of high load self-ignition, the NVO injection of which contribution to torque generation is small can be reduced and, thus, the engine operation efficiency can be improved as a whole.

Note that, if the fuel pressure of the NVO injection and the fuel pressure of the main injection in the same cylinder cycle are made equal when the engine operating state is in the HCCI mode, the fuel pressure of the main injection will be higher compared with the conventional method; thereby, microatomization of the fuel will be stimulated. For this reason, adhesion of the main fuel to the inner wall of the combustion chamber at the time of high load self-ignition can be prevented or suppressed without complicating the control mechanism of fuel pressure.

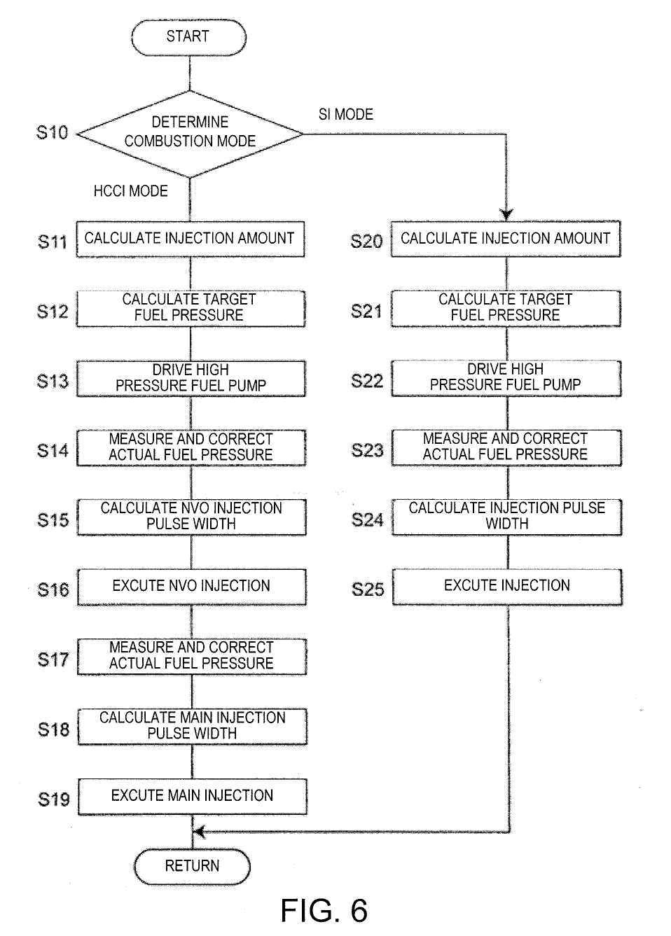

Hereinafter, according to the flowchart shown in FIG. 6, the control technique of the fuel injection control performed by the PCM 30 (especially, by the fuel injection control module) is described in detail. As shown in FIG. 6, when the fuel injection control is started (start), first, determination of combustion mode is performed at Step S10. Specifically, using the control map shown in FIG. 2, for example, and based on the engine load and the engine speed (namely, engine rotation speed), if the engine operating state is within the HCCI range [A], the PCM 30 determines that the engine is in the HCCI mode, and if the operating state is in the SI range [B], the PCM 30 determines that the engine is in the SI mode. At Step S10, if the PCM 30 determines that combustion mode is HCCI mode, Steps S11-S19 are performed in this order, and the NVO injection and the main injection is performed by the fuel injection valve 18, and fuel is combusted by compressed self ignition without performing ignition by the spark plug 16.

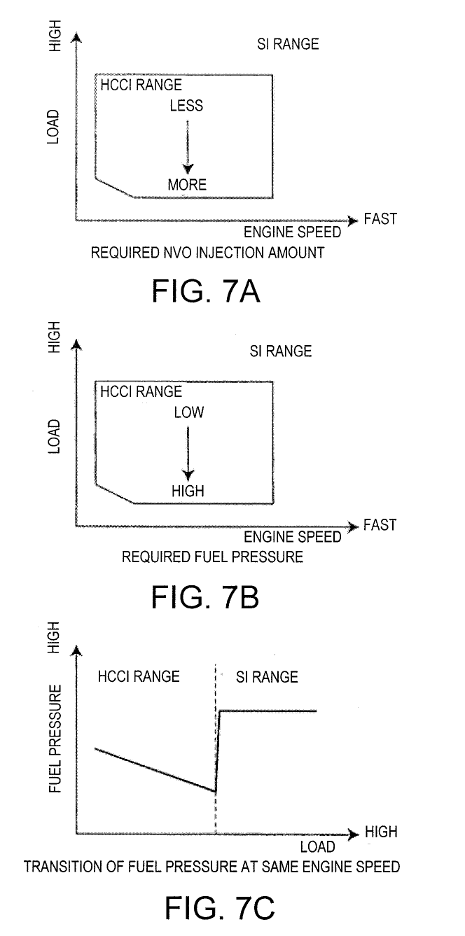

Hereinafter, specific control operations in the HCCI mode performed at Steps S11-S19 are first described. At Step S11, a fuel injection amount for the NVO injection (hereinafter, referred to as an “NVO injection amount”) and a fuel injection amount for the main injection (hereinafter, referred to as a “main injection amount”) are calculated. Here, the NVO injection amount is calculated based on the engine load and the engine speed using the control map shown in FIG. 7A, for example.

As shown in FIG. 7A, the NVO injection amount is set on the control map so that it increases as the engine load becomes smaller. Thus, because the NVO injection amount is increased as the engine load becomes smaller to increase the amount of heat generation by combustion of the NVO fuel, the self-ignition temperature near a compression top dead center can be secured also in the low load range where the temperature of internal EGR is low; thereby the HCCI range can be expanded to a lower load side. On the other hand, the main injection amount is calculated by an ordinary technique based on the engine load and the engine speed so that a desired engine torque can be obtained. Note that the NVO injection amount is less compared with the main injection amount.

At Step S12, a target fuel pressure is calculated. The target fuel pressure is calculated based on the engine load and the engine speed using the control map shown in FIG. 7B, for example. As shown in FIG. 7B, the target fuel pressure is set on the control map so that it increases as the engine load becomes smaller. FIG. 7C shows an example of a change characteristic of a fuel pressure with respect to the engine load when the engine speed is constant. As shown in FIG. 7C, in this embodiment, if the engine speed is constant in the HCCI range, then the fuel pressure linearly falls with the increase of load. The target fuel pressure is common to the NVO injection and the main injection.

Thus, because the fuel pressure is made higher as the engine load becomes smaller, although the NVO injection amount is comparatively large in a low load range, there is almost no necessity to increase the injection period and, thus, the fuel can be certainly injected during the very short NVO period. Further, because the fuel pressure is high, microatomization of the fuel is stimulated, flammability of the fuel becomes good, and generation of smoke resulting from the increase in the NVO injection amount can be prevented or suppressed.

At Step S13, the high-pressure fuel pump 19 is driven so that the target fuel pressure calculated at Step S12 is realized. At Step S14, based on the fuel pressure detected by the fuel pressure sensor 37, the fuel pressure is corrected so that the target fuel pressure is realized. At Step S15, based on the NVO injection amount and the fuel pressure, an injection pulse width of the NVO injection (i.e., a valve open period of the fuel injection valve 18 in the NVO injection) is calculated. Note that the fuel injection amount is generally proportional to the product of the fuel pressure and the valve open period (the injection pulse width) of the fuel injection valve 18. At Step S16, the fuel injection valve 18 is opened by the injection pulse width calculated at Step S15 to perform the NVO injection.

At Step S17, based on the fuel pressure detected by the fuel pressure sensor 37, the fuel pressure is again corrected so that the target fuel pressure is realized. The reason why the fuel pressure is again corrected is because there is a possibility that the fuel pressure may change a little by the NVO injection. At Step S18, an injection pulse width of the main injection (i.e., a valve open period of the fuel injection valve 18 in the main injection) is calculated based on the main injection amount and the fuel pressure. At Step S19, the fuel injection valve 18 is opened by the injection pulse width calculated at Step S18 to perform the main injection. Then, the PCM 30 returns to Step S10 (return).

If the PCM 30 determines that the combustion mode is the SI mode at Step S10, it performs Steps S20-S25 in this order, an ordinary fuel injection is performed by the fuel injection valve 18, and the fuel is combusted by ignition of the spark plug 16. Hereinafter, specific control operations in the SI mode performed at Steps S20-S25 are described.

At Step S20, a fuel injection amount is calculated by an ordinary technique based on the engine load and the engine speed. At Step S21, a target fuel pressure is calculated based on the engine speed. As shown in FIG. 7C, in this embodiment, if the engine speed is constant in the SI range, then the fuel pressure is also constant regardless of the load. Note that, as clear from FIG. 7C, the fuel pressure in the SI mode is set higher than the fuel pressure at the time of the low load in the HCCI mode.

At Step S22, the high-pressure fuel pump 19 is driven so that the target fuel pressure calculated at Step S21 is realized. At Step S23, based on the fuel pressure detected by fuel pressure sensor 37, the fuel pressure is corrected so that the target fuel pressure is realized. At Step S24, an injection pulse width of the fuel injection (i.e., a valve open period of the fuel injection valve 18) is calculated based on the fuel injection amount and the fuel pressure. At Step S25, the fuel injection valve 18 is opened by the injection pulse width calculated at Step S24 to perform a fuel injection. Then, the PCM 30 returns to Step S10 (return).

In this fuel injection control, heat of hot combusted gas (i.e., internal EGR) of a preceding cycle and combustion heat of the fuel by the NVO injection are used as heat sources of compressed self ignition for the next cycle in the HCCI mode. Because the temperature of the internal EGR (exhaust temperature) is low at the time of low load, in order to certainly perform compressed self ignition of the fuel or air fuel mixture, it is necessary to increase the amount of heat from the heat sources for the compressed self ignition compared with the high load. Here, as techniques of increasing the amount of heat from the heat sources for the compressed self ignition, a technique of lengthening the NVO period to increase the amount of internal EGR and a technique of increasing the NVO injection amount may be considered.

If the balance of fuel consumption and controllability is taken into consideration, the technique of increasing the NVO injection amount may be more advantageous than the technique of lengthening the NVO period. The NVO injection amount can be increased by expanding the injection pulse width of the fuel injection valve 18 or by raising the fuel pressure. Here, if both are compared, because micro atomization of the fuel is stimulated if the fuel pressure is raised rather than if the injection pulse width of the fuel injection valve 18 is simply expanded, thereby it is advantageous to raise fuel pressure because smoke is reduced for that amount of increase in the fuel pressure. Therefore, in this fuel injection control, the NVO injection amount is increased by raising the fuel pressure. Thus, in the case that the NVO injection amount is increased by raising the fuel pressure, it is preferred to raise the fuel pressure so that a predetermined NVO injection amount is secured while maintaining the injection pulse width of the NVO injection at the minimum injection pulse width.

As described above, according to the embodiment of the present invention, the NVO injection in the HCCI mode expands the HCCI range to a lower load side, and can certainly perform an injection at a desired timing with a desired quantity of fuel during the very short NVO period. For this reason, the self-ignition temperature near a compression top dead center can be secured, and generation of smoke resulting from the increase in the NVO injection amount can be prevented or suppressed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of controlling an internal combustion engine system having an internal combustion engine, and a fuel injector which directly injects fuel into a combustion chamber of said internal combustion engine, the method comprising:
when a desired torque for said internal combustion engine system is equal to or greater than a first torque:
opening an exhaust valve of a combustion chamber of said internal combustion engine and injecting pilot fuel into said combustion chamber at a first pressure before an exhaust top dead center in a cylinder cycle,
opening an intake valve of said combustion chamber in the cylinder cycle after said injecting of pilot fuel, and
injecting main fuel in the cylinder cycle after said opening of said intake valve so that the main fuel is self ignited after said intake valve is closed in the cylinder cycle; and
when a desired torque for said internal combustion engine system is less than said first torque:
opening said exhaust valve and injecting pilot fuel into said combustion chamber at a second pressure that is greater than said first pressure before an exhaust top dead center in a cylinder cycle,
opening said intake valve in the cylinder cycle after said injecting of pilot fuel, and
injecting main fuel in the cylinder cycle after said opening of said intake valve so that the main fuel is self ignited after said intake valve is closed in the cylinder cycle.

2. The method as described in claim 1, wherein an amount of the pilot fuel when the desired torque for said internal combustion engine system is less than said first torque is greater than an amount of the pilot fuel when the desired torque for said internal combustion engine system is equal to or greater than said first torque.

3. The method as described in claim 2, wherein the pilot fuel and the main fuel are injected at a substantially same pressure in a cylinder cycle.

4. The method as described in claim 3, further comprising:
when a desired torque for said internal combustion engine system is greater than a second torque that is greater than said first torque,
injecting additional fuel into said combustion chamber at a third pressure that is greater than said first pressure, and
igniting the injected additional fuel with a spark.

5. The method as described in claim 4, wherein said third pressure is greater than said second pressure.

6. The method as described in claim 1, wherein the pilot fuel and the main fuel are injected at a substantially same pressure in a cylinder cycle.

7. The method as described in claim 6, further comprising:
when a desired torque for said internal combustion engine system is greater than a second torque that is greater than said first torque,
injecting a supply of fuel into said combustion chamber at a third pressure that is greater than said first pressure, and
igniting the injected supply of fuel with a spark.

8. The method as described in claim 7, wherein said third pressure is greater than said second pressure.

9. The method as described in claim 1, further comprising:
when a desired torque for said internal combustion engine system is greater than a second torque that is greater than said first torque:
injecting a supply of fuel into said combustion chamber at a third pressure that is greater than said first pressure, and
igniting the injected supply of fuel with a spark.

10. The method as described in claim 9, wherein said third pressure is greater than said second pressure.

11. An internal combustion engine system comprising:
an internal combustion engine;
a fuel injector which directly injects fuel into a combustion chamber of said internal combustion engine; and
a controller configured to control:
an exhaust valve of a combustion chamber of said internal combustion engine to open and said fuel injector to inject pilot fuel into said combustion chamber at a first pressure before an exhaust top dead center in a cylinder cycle, an intake valve of said combustion chamber to open in the cylinder cycle after said injecting pilot fuel, and said fuel injector to inject main fuel in the cylinder cycle after said opening of said intake valve so that the main fuel is self ignited in the cylinder cycle after said intake valve is closed, when a desired torque for said internal combustion engine system is equal to or greater than a first torque; and
said exhaust valve to open and said fuel injector to inject pilot fuel into said combustion chamber at a second pressure that is greater than said first pressure before an exhaust top dead center in a cylinder cycle, said intake valve to open in the cylinder cycle after said injecting pilot fuel, and said fuel injector to inject main fuel in the cylinder cycle after said opening of said intake valve so that the main fuel is self ignited in the cylinder cycle after said intake valve is closed, when a desired torque for said internal combustion engine system is less than said first torque.

12. The system as described in claim 11, wherein an amount of the pilot fuel when the desired torque for said internal combustion engine system is less than said first torque is greater than an amount of the pilot fuel when the desired torque for said internal combustion engine system is equal to or greater than said first torque.

13. The system as described in claim 12, wherein the pilot fuel and the main fuel are injected at a substantially same pressure in a cylinder cycle.

14. The system as described in claim 13, further comprising a spark plug for said combustion chamber, and wherein said controller is further configured to control said fuel injector to inject a supply of fuel into said combustion chamber at a third pressure that is greater than said first pressure, and to control said spark plug to ignite the injected supply of fuel with a spark, when a desired torque for said internal combustion engine system is greater than a second torque that is greater than said first torque.

15. The system as described in claim 14, wherein said third pressure is greater than said second pressure.

16. The system as described in claim 11, wherein the pilot fuel and the main fuel are injected at a substantially same pressure in a cylinder cycle.

17. The system as described in claim 16, further comprising a spark plug for said combustion chamber, and wherein said controller is further configured to control said fuel injector to inject a supply of fuel into said combustion chamber at a third pressure that is greater than said first pressure, and to control said spark plug to ignite the injected supply of fuel with a spark, when a desired torque for said internal combustion engine system is greater than a second torque that is greater than said first torque.

18. The system as described in claim 17, wherein said third pressure is greater than said second pressure.

19. The system as described in claim 11, further comprising a spark plug for said combustion chamber, and wherein said controller is further configured to control said fuel injector to inject a supply of fuel into said combustion chamber at a third pressure that is greater than said first pressure, and to control said spark plug to ignite the injected supply of fuel with a spark, when a desired torque for said internal combustion engine system is greater than a second torque that is greater than said first torque.

20. The system as described in claim 19, wherein said third pressure is greater than said second pressure.
